(19) United States
(12) Patent Application Publication
(10) Pub. No.: US 2010/0329188 A1
(43) Pub. Date: Dec. 30, 2010

(54) Method for Handling Transmission Status and Related Communication Device

(76) Inventor: Yu-Chih Jen, Taoyuan County (TW)

Correspondence Address: NORTH AMERICA INTELLECTUAL PROPERTY CORPORATION, P.O. BOX 506, MERRIFIELD, VA, 22116, US

(21) Appl. No.: 12/826,566

(22) Filed: Jun. 29, 2010

Related U.S. Application Data
(60) Provisional application No. 61/221,098, filed on Jun. 29, 2009.

(51) Int. Cl. H04W 40/00

(52) U.S. Cl. 370/328

(57) ABSTRACT

A method for handling transmission and transmission status information for a relay capable of conveying data between a mobile device and a base station in a wireless communication system comprises the steps of autonomously handling uplink (UL)/downlink (DL) transmission, a UL/DL transmission report, a UL/DL reception report and resources of the UL/DL transmission when the relay receives the UL/DL transmission or the UL/DL transmission report or the UL/DL reception report, or receives a feedback signals corresponding to the UL/DL transmission.

### CROSS REFERENCE TO RELATED APPLICATIONS

This application claims the benefit of U.S. Provisional Application No. 61/221,098, filed on Jun. 29, 2009 and entitled “Method and Apparatus for enhancing scheduling, MAC operation and scheduled resource management” the contents of which are incorporated herein.

### BACKGROUND OF THE INVENTION

1. Field of the Invention

A method used in a wireless communication system and related communication device are disclosed, and more particularly to, a method of handling transmission status information for a wireless communication system and related communication device.

2. Description of the Prior Art

A long-term evolution (LTE) system, initiated by the third generation partnership project (3GPP), is now being regarded as a new radio interface and radio network architecture that provides a high data rate, low latency, packet optimization, and improved system capacity and coverage. In the LTE system, a radio access network known as an evolved universal terrestrial radio access network (E-UTRAN) includes a plurality of evolved Node-Bs (eNBs) for communicating with a plurality of user equipments (UEs) and communicates with a core network including a mobility management entity (MME), serving gateway, etc for NAS (Non Access Stratum) control.

A long term evolution-advanced (LTE-A) system, as its name implies, is an evolution of the LTE system, considering relaying for cost-effective throughput enhancement and coverage extension. For example, a relay can be deployed at the cell edge where the eNB is unable to provide required radio quality/throughput for the UEs or at certain location where radio signals of the eNB cannot cover. The LTE-A system can support a wider bandwidth up to 100 MHz to satisfy requirement for peak data rate. A carrier aggregation where two or more component carriers are aggregated is employed for the LTE-A system to achieve wider-band transmission. An LTE-A specification supports carrier aggregation for both continuous and non-continuous component carrier with each component carrier limited to a maximum of 110 resource blocks. The carrier aggregation increases spectrum flexibility by aggregating the component carriers in the different frequency band (non-continuous spectrum).

In the LTE and LTE-A system, a technique of transmission time interval (TTI) bundling is introduced for improving uplink coverage according to the prior art. TTI bundling is performed by repeatedly transmitting a same packet with default times, and those repeatedly transmitted packets are named a bundle. The UEs in cell boundary utilizing TTI bundling can reduce transmission delay and signaling of control channels for enhancing reliability and accuracy of transmission, to improve LTE uplink coverage. In addition, Discontinuous Reception (DRX) functionality is applied to a media access control (MAC) layer for allowing the UE to enter a standby mode during certain periods of time and stopping monitoring a Physical down Link Control Channel (PDCCH), so as to reduce power consumption of the UE. In cases of using the DRX functionality, whenever a new DRX cycle begins, an On Duration Timer is started for awaking the UE to monitor the PDCCH until the On Duration Timer expires. In addition, when a DRX Inactivity Timer or a DRX Retransmission Timer is strated, the UE also monitors the PDCCH.

The relaying technology is considered for the LTE-A system as a tool to improve e.g. the coverage of high data rates, group mobility, temporary network deployment, the cell-edge throughput and/or to provide coverage in new areas. The relay node is wirelessly connected to radio-access network via a donor cell. The connection associated with the relay can be in band transmission or out band transmission. For the in band transmission, the network-to-relay link share the same band with direct network-to-UE links within the donor cell. For the out band transmission, the network-to-relay link does not operate in the same band as direct network-to-UE links within the donor cell.

The relay can assist downlink/uplink (DL/UL) transmission for the UE where UL/DL resource may be prescheduled at the relay or the relay simply snoops control signaling and/or transmission/feedback. The relay should be able to decide whether to continue the retransmission/feedback for the UE or base station or whether the DL/UL resource for the transmission/feedback can be released or not in the following situations:

(1) when the relay receives a physical downlink share channel (PDSCH) to the UE or the acknowledgement of the PDSCH from the UE;

(2) when the relay receives a PUSCH from the UE to a base station or receives the acknowledgement of the PUSCH from the base station.

To ensure no misunderstanding and scheduling problem, it's very important for the UE to at least make sure the transmission/reception status or acknowledgement result. A media access control (MAC) layer at the relay may cause acknowledgement errors or new data indicator (NDI) errors if having not enough information about the transmission/reception status or acknowledgement result.

To fulfill relay functions, it's very important to make sure UEs under relay coverage have accurate DL/UL synchronization. However, since some UEs under relay coverage may be much closer to the base station than other UEs under the same relay coverage, the relay node uses aligned synchronization (e.g. by synchronization signal) for all UEs under relay may not be suitable (e.g. affect reception throughput and transmission interference). For relay with or without cell identity, the timing alignment method may be different (e.g. DL synchronization and timing alignment).

On the other hand, since relay cannot transmit and receive in band at the same time, to maintain 8ms UL synchronous transmission structure and acknowledgement feedback timing, scheduling (e.g. PUSCH, PDSCH, UL/DL feedback) between relay and UE should taken into account scheduling between base station and relay. Besides, scheduling related to measurement gap configuration, TTI bundling and DRX configuration between relay and UE should be taken into account scheduling between base station and relay.

### SUMMARY OF THE INVENTION

A method for handling transmission status information for a relay capable of conveying data between a mobile device and a base station in a wireless communication system is disclosed to enhance scheduling and resource management.

A method for handling transmission and transmission status information for a relay capable of conveying data between a mobile device and a base station in a wireless communication system is disclosed. The method comprises autonomously handling a first transmission, a first transmission report, a first reception report, a first feedback signal or resources for the first transmission, the first transmission report, the first reception report or the first feedback signal when the relay receives the first transmission or the first transmission report from the base station, or receives the first reception report or the first feedback signal from the mobile device, wherein the first transmission carries data or signaling that the base station attempts to send to the mobile device; and autonomously handling a second transmission, a second transmission report, a second reception report, a second feedback signal or resources for the second transmission, the second transmission report, the second reception report or the second feedback signal when the relay receives the second transmission or the second transmission report from the mobile device, or receives the second reception report or a second feedback signal from the base station, wherein the second transmission carries data or signaling that the mobile device attempts to send to the base station

A method for handling transmission status information for a communications device in a wireless communication system is disclosed. The method comprising configuring a physical layer entity of the communications device to provide a medium access control (MAC) layer entity of the communications device with information of the physical layer entity associated with a transmission, a retransmission or related report or feedback signal and configuring the MAC layer entity to performing a hybrid automatic repeat request procedure according to the information.

A method for handling synchronization for a relay capable of conveying data between a mobile device and a base station in a wireless communication system is disclosed. The method comprises transmitting a synchronization signal with a specific feature to the mobile device, wherein the mobile device performs synchronization with the relay according to the synchronization signal.

A method for handling synchronization for a mobile device in a wireless communication system is disclosed. The method comprising performing a first random access (RA) procedure to a base station, acquiring a first uplink synchronization with the base station according to the first RA procedure, performing a second RA procedure to a relay and acquiring a second uplink synchronization with the relay according to the second RA procedure.

A method for handling synchronization for a first communication device a wireless communication system is disclosed. The first communication device has a first uplink synchronization of a mobile device to the first device. The method comprises acquiring a second uplink synchronization of the mobile device to a second communication device according to the first uplink synchronization.

A method for handling transmission scheduling for a first communication device in a wireless communication system is disclosed. The method comprises scheduling uplink transmission from a mobile device to the first communication device or a second communication device according to at least one of synchronous uplink transmission, HARQ operation related to a UL grant, timing of downlink feedback of the uplink transmission and an in-band operation of a relay and scheduling downlink transmission to a mobile device from the first communication device or the second communication device according to at least one of adaptive downlink assignment, timing of uplink feedback of the downlink transmission and an in-band operation of the relay.

A method for handling behavior corresponding to scheduling for a mobile device in a wireless communication system is disclosed. The method comprises receiving configuration indicating a measurement gap and not performing measurement during a period within the measurement gap.

A method for handling behavior corresponding to scheduling for a mobile device in a wireless communication system is disclosed. The method comprises receiving configuration indicating a bundle length and performing transmission time interval (TTI) bundling operation according to the bundle length when the mobile device is under coverage of a relay of the wireless communication system.

A method for handling transmission status information for a first communication device in a wireless communication system is disclosed. The method comprises the steps of enabling a discontinuous reception function configuring an On-Duration during which the mobile device has to wake up and not waking up to perform reception during a period of the On-Duration.

A method for handling behavior corresponding to scheduling for a mobile device in a wireless communication system is disclosed. The method comprises enabling a discontinuous reception function configuring an On-Duration during which the mobile device has to wake up and not waking up to perform reception during a period of the On-Duration.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a wireless communication system according to an example of the present disclosure.

FIG. 2 is a schematic diagram of a communication device according to an example of the present disclosure.

FIG. 3 illustrates a schematic diagram of the program code in FIG. 2.

FIG. 4 is a flowchart of a process according to an example of the present disclosure.

FIG. 5 is a flowchart of a process according to an example of the present disclosure.

FIG. 6 is a flowchart of a process according to an example of the present disclosure.

FIG. 7 is a flowchart of a process according to an example of the present disclosure.

FIG. 8 is a flowchart of a process according to an example of the present disclosure.

FIG. 9 is a flowchart of a process according to an example of the present disclosure.

FIG. 10 is a flowchart of a process according to an example of the present disclosure.

FIG. 11 is a flowchart of a process according to an example of the present disclosure.

FIG. 12 is a flowchart of a process according to an example of the present disclosure.

### DETAILED DESCRIPTION

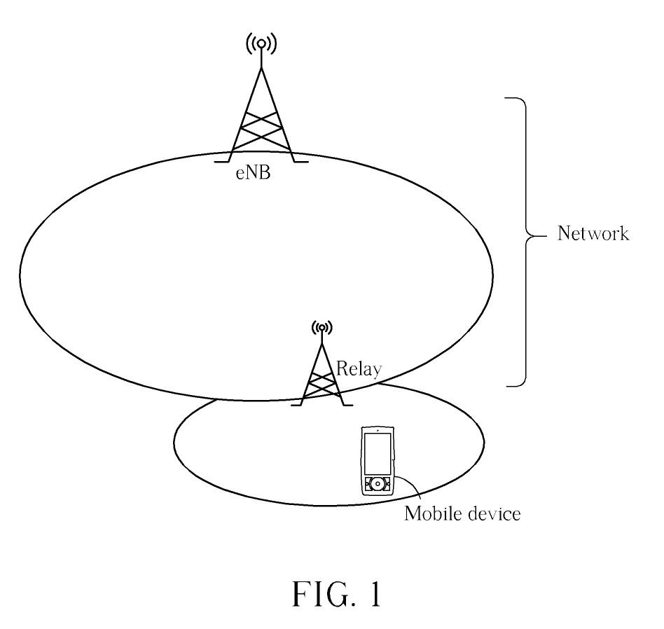

Please refer to FIG. 1, which is a schematic diagram of a wireless communication system 10 according to an example of the present disclosure. The wireless communication system 10, such as an LTE-A (long-term evolution-advanced) system or other mobile communication systems supporting multiple component carriers with which simultaneous data transmission and/or reception can be performed, is briefly composed of a network and a plurality of user equipments (UEs). In FIG. 1, the network and the UEs are simply utilized for illustrating the structure of the wireless communication system 10. Practically, the network can be referred as to an E-UTRAN (evolved-UTAN) comprising a plurality of evolved Node-Bs (eNBs) and relays in the LTE-A system. The relays are deployed to improve the coverage of high data rates, group mobility, temporary network deployment, the cell-edge throughput and provide coverage in new areas. The relay node is wirelessly connected to the network via a donor cell. The UEs can be devices such as mobile phones, computer systems, etc. Besides, the network and the UE can be seen as a transmitter or receiver according to transmission direction, e.g., for uplink (UL), the UE is the transmitter and the network is the receiver, and for downlink (DL), the network is the transmitter and the UE is the receiver.

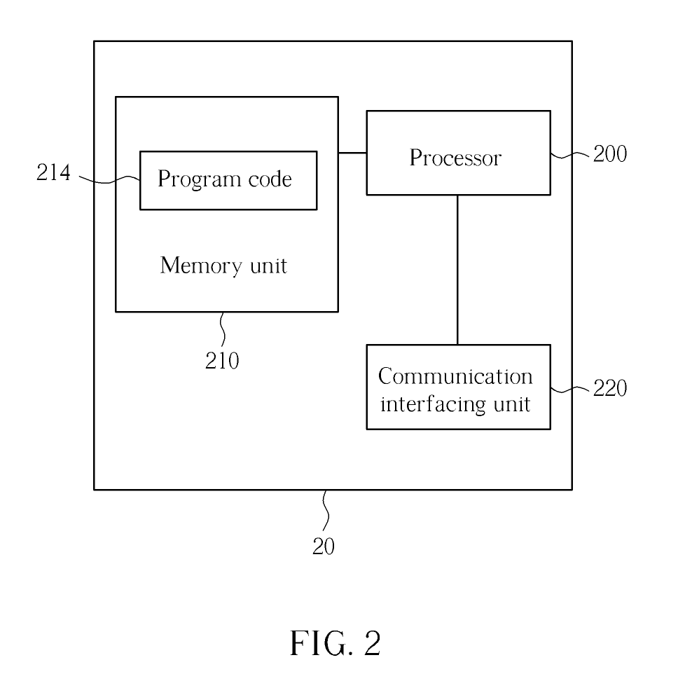

Please refer to FIG. 2, which is a schematic diagram of a communication device 20 according to an example of the present disclosure. The communication device 20 can be the UE or the network shown in FIG. 1 and includes a processor 200, a computer readable recording medium 210 and a communication interfacing unit 220. The computer readable recording medium 210 maybe any data storage device that stores storage data 212, including program code 214, thereafter read and processed by the processor 200. Examples of the computer readable recording medium 210 include a subscriber identity module (SIM), read-only memory (ROM), random-access memory (RAM), CD-ROMs, magnetic tapes, hard disks, optical data storage devices, and carrier waves (such as data transmission through the Internet). The communication interfacing unit 220 is preferably a radio transceiver for wirelessly communicating with other communication devices and can transform process results from the processor 200 into radio signals.

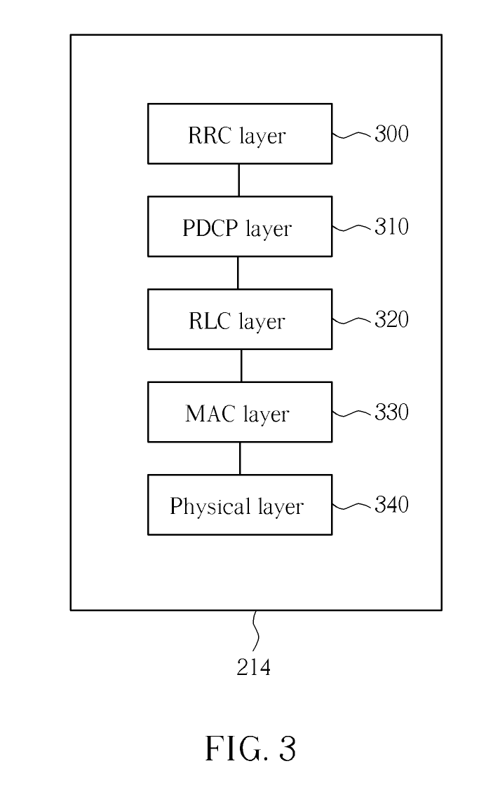

Please refer to FIG. 3, which illustrates a schematic diagram of the program code 214 for the LTE system according to an example. The program code 214 includes program code of multiple communications protocol layers, which from top to bottom are a radio resource control (RRC) layer 300, a packet data convergence protocol (PDCP) layer 310, a radio link control (RLC) layer 320, a medium access control (MAC) layer 330 and a physical (PHY) layer 340. The MAC layer 330 supports discontinuous reception (DRX) functionality. The DRX functionality is executed by the MAC layer 330 according to Radio Resource Control (RRC) commands of the RRC layer 300. The MAC layer 330 should be provided more information from the PHY layer 340 when the communication device 20 is a relay or a UE, so as to solve problems such as feedback signal (e.g. an acknowledgement (ACK) or a negative acknowledgement (NACK)) errors or new data indicator (NDI) errors.

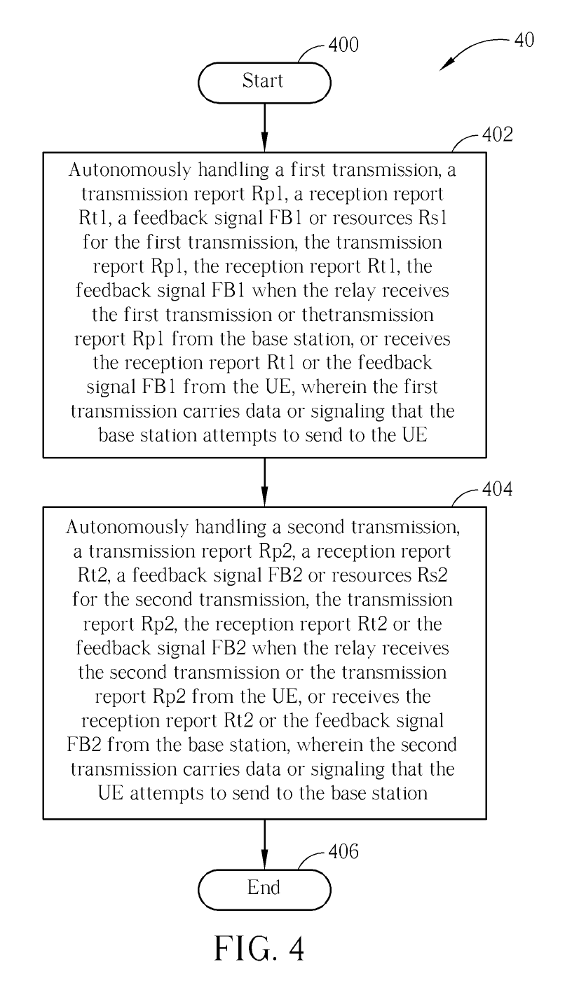

Please refer to FIG. 4, which is a flowchart of a process 40 according to an example of the present disclosure. The process 40 is used for handling transmission status information for a relay capable of conveying data between a UE and a base station (e.g. eNB) in a wireless communication system. Preferably, the wireless communication system can be referred as to the wireless communication system 10 and includes the base station and the UE. The process 40 may be complied into the program code 214 and includes the following steps:

Step 400: Start.

Step 402: Autonomously handling a first transmission or a transmission report Rp1 to the UE, or a reception report Rt1, a feedback signal FB1 corresponding to the first transmission or resources Rs1 for the first transmission, the transmission report Rp1, the reception report Rt1, the feedback signal FB1 corresponding to the first transmission when the relay receives the first transmission or the transmission report Rp1 from the base station, or receives the reception report Rt1 or the feedback signal FB1 corresponding to the first transmission from the UE, wherein the first transmission carries data or signaling that the base station attempts to send to the UE.

Step 404: Autonomously handling a second transmission, a transmission report Rp2 to the base station, a reception report Rt2, a feedback signal FB2 corresponding to the second transmission or resources Rs2 for the second transmission, the transmission report Rp2, the reception report Rt2 or the feedback signal FB2 corresponding to the second transmission when the relay receives the second transmission or the transmission report Rp2 from the UE, or receives the reception report Rt2 or the feedback signal FB2 corresponding to the second transmission from the base station, wherein the second transmission carries data or signaling that the UE attempts to send to the base station

Step 406: End.

According to the process 40, when the relay may receive the first transmission, the transmission report Rp1 from the base station or the reception report Rt1 or the feedback signal FB1 from the UE, the relay may determine whether to continue or forward the first transmission, the transmission report Rp1 to the UE/the reception report Rt1 to the base station/the feedback signal FB1 to the base station, or release the resources Rs1 for the first transmission, the transmission report Rp1, the reception report Rt1 or the feedback signal FB1 or reschedule the resources Rs1 for the first transmission, the transmission report Rp1, the reception report Rt1 or the feedback signal FBI. When the relay may receive the second transmission, the transmission report Rp2 from the UE or the reception report Rt2 and the feedback signal FB2 from the base station, the relay may determine whether to continue or forward the second transmission, the transmission report Rp2 to the base station/the reception report Rt2 to the UE/the feedback signal FB2 to the UE, or release the resources Rs2 for the second transmission, the transmission report Rp2, the reception report Rt2 or the feedback signal FB2, or reschedule the resources Rs12 for the second transmission, the transmission report Rp2, the reception report Rt2 or the feedback signal FB2. The report Rp1 may be referred as to a downlink (DL) transmission/retransmission report sent to the UE (e.g. buffer status report for DL transmission). The reception report Rt1 may be referred as to a radio link control (RLC) reception report sent by the UE. The feedback signal FB1 may be referred as to an acknowledgement feedback of DL transmission/retransmission sent by the UE. The first transmission, preferably, could be a DL transmission or retransmission on physical downlink share channel (PDSCH). The feedback signal FB1 may be referred as to an acknowledgement (ACK) or a negative acknowledgement (NACK). The transmission report Rp2 may be referred as to an uplink (UP) transmission/retransmission report sent to the base station (e.g. buffer status report for UL transmission). The reception report Rt2 may be referred as to a RLC reception report sent by the base station. The feedback signal FB2 may be referred as to an acknowledgement feedback of UL transmission/retransmission sent by the base station. The second transmission, preferably, could be a UL transmission or retransmission on physical downlink share channel (PDSCH). The feedback signal FB2 may be referred as to an acknowledgement (ACK) or a negative acknowledgement (NACK). In other words, when the relay receives the DL (re)transmission report, the reception report of the DL (re)transmission, the acknowledgement of the DL (re)transmission, the UL (re)transmission report, the reception report of the UL (re)transmission or the acknowledgement of the UL (re)transmission the relay may make its own decision to deal with those (re)transmission, reports and acknowledgement feedbacks from/to the UE or the base station.

In addition, the relay may indicates to the base station when the relay decides to continue or forward the first transmission, the transmission report Rp1 to the UE/the reception report Rt1 to the base station/the feedback signal FB1 to the base station. Also, the relay may indicate to the base station when the relay releases or reschedules the resources Rs1 for the first transmission, the transmission report Rp1, the reception report Rt1, the feedback signal FB1. The relay may indicates to the base station or the UE when the relay decides to continue or forward the second transmission, the transmission report Rp2 to the base station/the reception report Rt2 to the UE/the feedback signal FB2 to the UE. The relay may indicate to the base station or the UE when the relay releases or reschedule the resources Rs2 the second transmission, the transmission report Rp2, the reception report Rt2, the feedback signal FB2. In some examples, the relay may indicate to the base station when the relay determines not to continue or forward the first transmission or the transmission report Rp1 to the UEe, or the reception report Rt1 or the feedback signal FB1 to the base station or the relay may indicate to the base station or the mobile device when the relay determines not to continue or forward the second transmission or the transmission report Rp2 to the base station, or the reception report Rt2 or the feedback signal FB2 to the UE.

In some examples, the relay may assist the first transmission or/and the second transmission (e.g. DL/UL) in sending the data or signaling for the first transmission or/and the second transmission for the UE, when the resource Rs1 for the first transmission or/and the resource Rs2 for the second transmission have been scheduled at the relay in advanced or when the relay snoops control signalings that are uses for the first transmission or/and the second transmission. Namely, the relay assists DL/UL transmission for the UE where the DL/UL resource may be prescheduled at the relay or the relay simply snoops the control signaling and/or transmission feedback. Therefore, according to examples, the relay should be able to decide whether to continue the (re)transmission for the UE or the base station, or whether the DL/UL resource for the (re)transmission/feedback can be released or not.

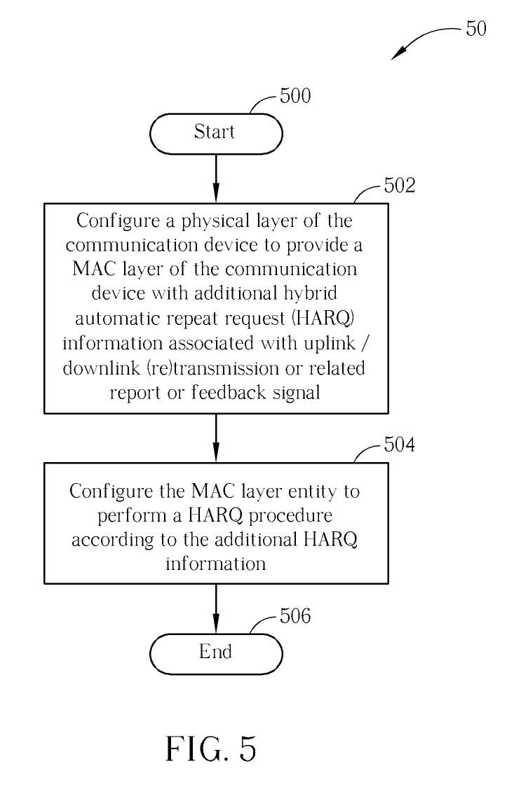

Please refer to FIG. 5, which is a flowchart of a process 50 according to an example of the present disclosure. The process 50 is used for handling transmission and transmission status information for a communication device that may be a relay or a UE in a wireless communication system. Preferably, the wireless communication system can be referred as to the wireless communication system 10 and the communication device maybe referred as the communication device 20. The process 50 may be complied into the program code 214 and includes the following steps:

Step 500: Start.

Step 502: Configure a physical layer of the communication device to provide a MAC layer of the communication device with additional hybrid automatic repeat request (HARQ) information associated with uplink/downlink (re)transmission or related report or feedback signal.

Step 504: Configure the MAC layer entity to perform a HARQ procedure according to the additional HARQ information.

Step 506: End.

According to the process 50, the communication device may provide the MAC layer of the communication device additional HARQ information (e.g. additional acknowledgement, Redundancy Version (RV), new data indicator (NDI) and Transport Blocks (TBS)) associated with the uplink/downlink (re)transmission, related report or feedback signal by configuring the physical layer of the communication device. The physical layer may be referred as to the physical layer 340 in FIG. 3, and the MAC layer may be referred as to the MAC layer 330 in FIG. 3. The MAC layer of the communication device performs the HARQ procedure according to the additional HARQ information. With the additional HARQ information, the communication device may ensure a correct transmission/reception status or a acknowledge result, reducing HARQ procedure errors (e.g. acknowledge error or NDI error).

In some examples, the additional HAQR information may includes modulation and coding scheme (MCS) information (e.g. MCS index to 29, 30, 31), (re)transmission or reception timing (e.g. feedback timing or synchronous transmission relationship), correlation information (e.g. bit correlation percentage or similarity between two adjacent (re)transmission), power control level in relation to transmission times, and/or snooped control information. Besides, the MAC layer of the communication device may perform other functionalities such as determining whether the transmission is a new transmission or a retransmission or whether the retransmission is a new transmission or a retransmission; determining whether the received feedback signal (e.g. acknowledgement, RV, or NDI) is correct or not; continuing or forwarding the transmission or the retransmission at uplink or downlink; and releasing or rescheduling the resources for the transmission or the retransmission at uplink or downlink.

Thus, though the process 50, the MAC layer can obtain sufficient information, provided the PHY layer, about the transmission/reception status or acknowledgement result, so as to solve problems such as feedback signal or NDI errors

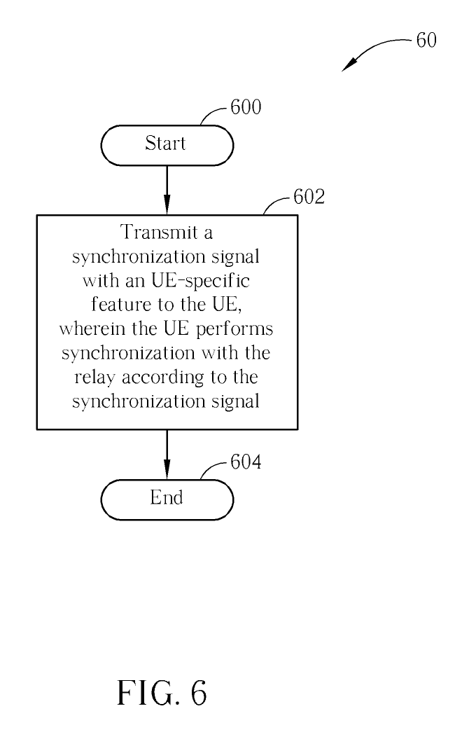

A relay may use aligned synchronization (e.g. by synchronization signal) for all UEs under coverage of the relay may not be suitable (e.g. affect reception throughput and transmission interference), especially when the UEs can receive downlink synchronization signals from both the relay and corresponding base station or when the relay transmits synchronization signal at the same subframe as the base station. Under such consideration, the disclosure provides several following processes to handle these situations. Please refer to FIG. 6, which is a flowchart of a process 60 according to an example of the present disclosure. The process 60 is used for handling synchronization for a relay capable of conveying data between a UE and a base station in a wireless communication system. Preferably, the wireless communication system can be referred as to the wireless communication system 10. The process 60 maybe complied into the program code 214 and includes the following steps:

Step 600: Start.

Step 602: Transmit a synchronization signal with an UE-specific feature to the UE, wherein the UE performs synchronization with the relay according to the synchronization signal.

Step 604: End.

According to the process 60, the relay may transmit the synchronization signal with the UE-specific feature to the UE. The UE specific feature may include the period and/or the pattern and/or the resource and/or the root sequence and/or cell information and/or transmitting power level. The pattern herein may be referred as to a deployment of resource elements in a resource block. In other word, the synchronization signal is UE-specific. When receiving the synchronization signal, the UE may perform synchronization with the relay. When multiple UEs are under the coverage of the relay, each UE may individually perform accurate uplink or downlink synchronization with the relay according to the synchronization signal. Such that the relay may apply different timing alignments to different UEs by sending the different UE-specific synchronization signals. Preferably, the relay may be operated in in-band transmission or out-band transmission. For the in-band transmission, the base station-to-relay link share the same band with direct base station-to-UE links within the donor cell. For the out band transmission, the base station-to-relay link does not operate in the same band as direct base station-to-UE links within the donor cell. Besides, the relay may be transparent or non-transparent to the UE.

The UE-specific feature (e.g. the period and/or the pattern and/or the resource and/or the root sequence and/or cell information and/or transmitting power level) maybe the same as the configurations used at the base station (e.g. donor base station), or different from the configurations used at the base station. In some examples, the synchronization signal is transmitted at the relay with the different periods, patterns (e.g. different or orthogonal resource elements), subframes, and/or frequency resource from the ones used at the base station. The relay and the base station may use the different root sequence for scrambling the synchronization signal. In some examples, the cell information carried in the synchronization signal at the relay is the same as the one carried in the synchronization signal at the base station. The relay may use the different cell identity than the one used by the base station or the same cell identity as the one used by the base station. In some examples, the relay may have no cell identity.

In addition, the resource of the synchronization signal may be allocated either by the relay or by the base station. The UE may detect the allocated resource once the resource is allocated. In some examples, the resource may be indicated to the UE either by the relay or by the base station. In this situation, the UE may maintain two DL synchronization (e.g. the base station-to-UE link or the relay-to-UE link). Or the UE may be able to choose which DL synchronization to maintain.

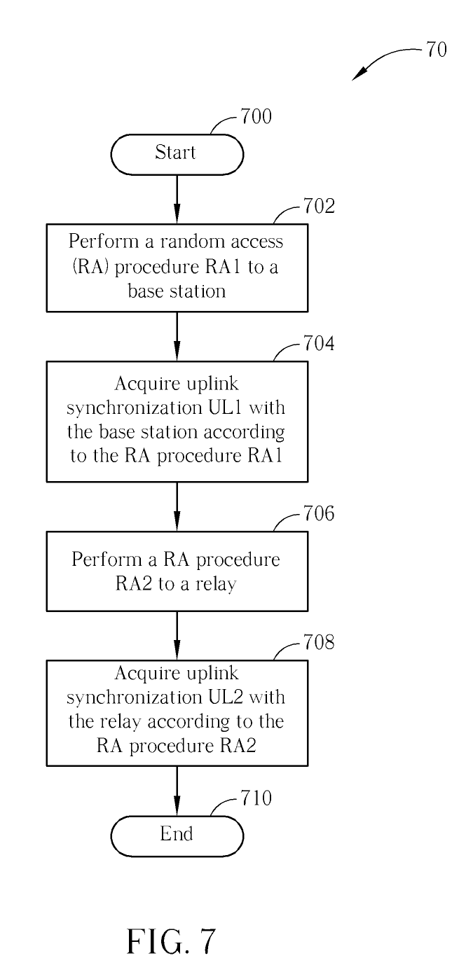

Please refer to FIG. 7, which is a flowchart of a process 70 according to an example of the present disclosure. The process 70 is used for handling synchronization for a UE in a wireless communication system. Preferably, the wireless communication system can be referred as to the wireless communication system 10. The process 70 maybe complied into the program code 214 and includes the following steps:

Step 700: Start.

Step 702: Perform a random access (RA) procedure RA1 to a base station.

Step 704: Acquire uplink synchronization UL1 with the base station according to the RA procedure RA1.

Step 706: Perform a RA procedure RA2 to a relay.

Step 708: Acquire uplink synchronization UL2 with the relay according to the RA procedure RA2.

Step 710: End.

According to the process 70, the UE may perform the RA procedure RA1 to the base station for acquiring the uplink synchronization UL1 of UE-to-Base station and perform the RA procedure RA2 to the relay for acquiring the uplink synchronization of UE-to-Relay. The uplink synchronization may be referred as to timing alignment or timing advanced command). Thus, the UE may maintain two uplink synchronizations UL1 and UL2 with the relay and the base station.

In some examples, the RA procedure RA1 and the RA procedure RA2 may be performed at the same given subframe. In some examples, the RA procedure RA1 may be performed only when the RA procedure RA2 has been completed. In other examples, the RA procedure RA2 may be performed only when the RA procedure RA1 has been completed. The relay may indicate to the base station about the uplink synchronization UL2 of UE-to-Relay. Or, the base station may indicate to the relay about the uplink synchronization UL1 of UE-to-Base station.

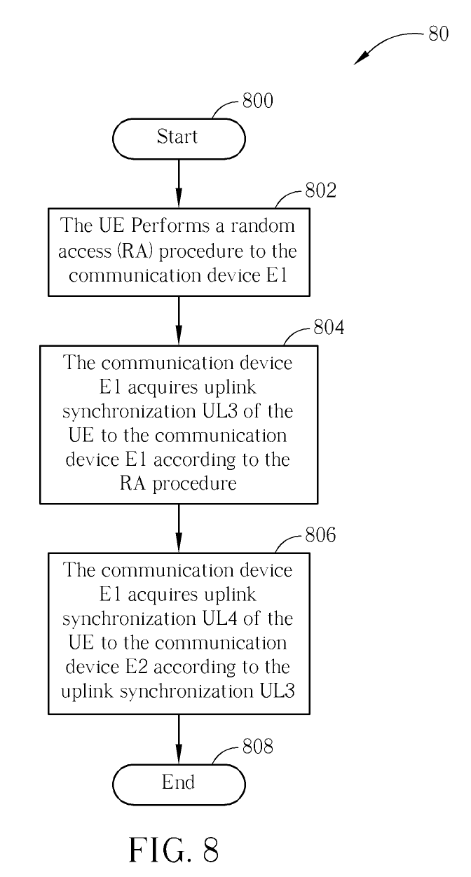

Please refer to FIG. 8, which is a flowchart of a process 80 according to an example of the present disclosure. The process 80 is used for handling synchronization information for a UE in a wireless communication system. Preferably, the wireless communication system includes a UE, a communication device E1 and a communication device E2. The process 80 may be complied into the program code 214 and includes the following steps:

Step 800: Start.

Step 802: The UE Performs a random access (RA) procedure to the communication device E1.

Step 804: The communication device E1 acquires uplink synchronization UL3 of the UE to the communication device E1 according to the RA procedure.

Step 806: The communication device E1 acquires uplink synchronization UL4 of the UE to the communication device E2 according to the uplink synchronization UL3.

Step 808: End.

According to the process 80, the UE may perform the RA procedure to the communication device E1 for acquiring the uplink synchronization UL3 (e.g. timing alignment or timing advance command) of UE-to-E1. Then, the communication device E1 may acquire the uplink synchronization UL4 (e.g. timing alignment or timing advance command) of UE-to-E2 according to the uplink synchronization UL3. When the UE have uplink synchronization with the communication device E1, the communication device E1 may acquire uplink synchronization (e.g. timing alignment or timing advance command) of E1-to-E2 or downlink synchronization DL1 of E2-to-E1 from the communication device E2 or indication and information sent by the communication device E1 (e.g. uplink synchronization estimation of UE-to-E1), thereby acquiring the uplink synchronization UL4 of UE-to-E2. In other words, the uplink synchronization UL3 is used for acquiring the uplink synchronization UL4. Thus, the communication device E1, may inform the UE of the uplink synchronization UL4 after acquiring the uplink synchronization UL4 through the uplink synchronization UL3.

In some examples, the communication device E1 may be referred as to a base station while the communication device E2 may be referred as to a relay. In some examples, the communication device E1 may be referred as to the relay while the communication device E2 may be referred as to the base station. For example, the communication device E1 is the base station and the communication device E2 is the relay. In this situation, the base station acquires the uplink synchronization of the UE to the relay according to the uplink synchronization of the relay to the base station, downlink synchronization of the base station to the relay, or the indication/information from the relay. Since the base station has the uplink synchronization of the UE to the base station, the base station may obtain the uplink synchronization of the UE to the relay by subtraction, compensation or estimation algorithm. When the communication device E1 is the relay and the communication device E2 is the base station. The relay acquires the uplink synchronization of the UE to the base station according to the downlink synchronization of the base station to the relay, uplink synchronization of the relay to the base station, or the indication/information from the base station. Since the relay has the uplink synchronization of the UE to the relay, the relay may obtain the uplink synchronization of the UE to the base station by subtraction, compensation or estimation algorithm.

The uplink synchronization UL3 and the uplink synchronization UL4 may consider transmission angle (or related location) between UE-to-E1 and E2-to-E1 and transmission angle between UE-to-E2 and E1-to-E2, respectively. In addition, the uplink synchronizations UL3 and UL4 may be indicated to the UE by the communication device E1 or the communication device E2. The uplink synchronizations UL3 and UL4 may be default values stored in the UE or the communication device E1 or the communication device E2.

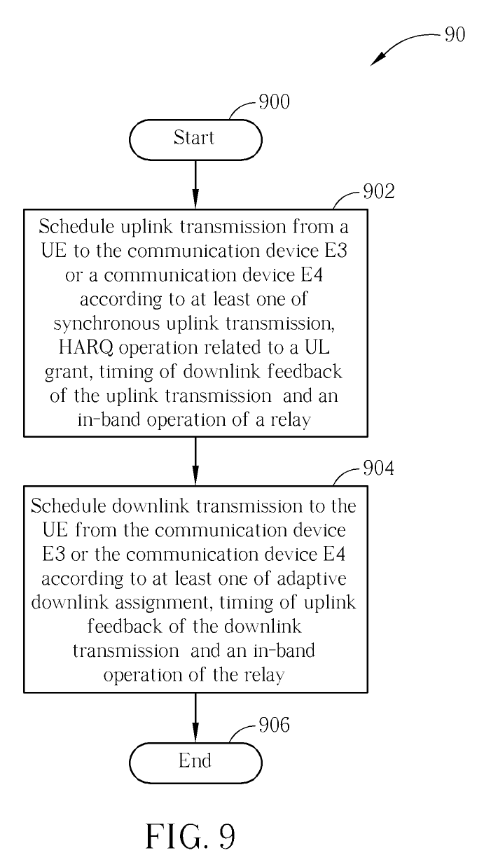

Please refer to FIG. 9, which is a flowchart of a process 90 according to an example of the present disclosure. The process 90 is used for handling transmission scheduling for a communication device E3 (e.g. relay or base station) in a wireless communication system. Preferably, the wireless communication system can be referred as to the wireless communication system 10. The process 90 may be complied into the program code 214 and includes the following steps:

Step 900: Start.

Step 902: Schedule uplink transmission from a UE to the communication device E3 or a communication device E4 according to at least one of synchronous uplink transmission, HARQ operation related to a UL grant, timing of downlink feedback of the uplink transmission and an in-band operation of a relay.

Step 904: Schedule downlink transmission to the UE from the communication device E3 or the communication device E4 according to at least one of adaptive downlink assignment, timing of uplink feedback of the downlink transmission and an in-band operation of the relay.

Step 906: End.

According to the process 90, If the uplink transmission is performed, the communication device E3 may schedule uplink transmission according to the synchronous uplink transmission (e.g. 8 ms uplink synchronous relationship) and/or the timing of the downlink feedback (e.g. 4ms after uplink transmission) of the uplink synchronization transmission and/or HARQ operation related to the UL grant. If the downlink transmission is performed, the communication device E3 may schedule downlink transmission according to adaptive downlink assignment and/or the timing of the uplink feedback of the downlink synchronization transmission.

Preferably, the communication device E3 is a serving base station or a serving cell while the communication device E4 is the relay. Or, the communication device E3 is the relay while the communication device E4 is the serving base station. In some examples, the relay and the serving base station may have the same cell identity or different cell identities. Besides, the relay could be transparent or non-transparent to the mobile device.

For the uplink transmission, the downlink feedback of the uplink transmission and the uplink feedback of the downlink transmission, the communication device E3 may schedule multiple subframes. For example, the communication device E3 may schedule a subframe(N) for the UE-to-E3 uplink transmission. In this situation, any subframe [(N+8)mod(10)] is scheduled for the UE-to-E3 uplink transmission as well due to “8 ms uplink synchronous relationship”. In other words, the subframes [(N+8)mod(10)] can not be scheduled for the uplink transmission for the relay to the base station. For the downlink feedback of the UE-to-E3 uplink transmission, the communication device E3 may schedule subframe [(N+4)mod(10)] due to “4ms after uplink transmission”. Such that, the subframe [(N+4)mod(10)] can not be scheduled for any downlink transmission for the base station to relay. If the subframe (N) is scheduled for the downlink reception, the communication device E3 may schedule subframe [(N+4)mod(10)] due to “4 ms after uplink transmission” for the uplink feedback of the downlink transmission. Such that, the subframe [(N+4)mod(10)] can not be scheduled for any uplink transmission for the relay to the base station. In some examples, the communication device E3 or the UE may postpone or avoid the multiple subframes for the uplink transmission. For example, the UE attempt to perform the uplink transmission to the relay or receive the feedback from the relay at the subframe(N). Meanwhile, the relay attempt to perform the uplink transmission to the base station or receive the feedback from the base station at the subframe(N). Since the relay can not transmit or receive at the same subframe, one of the UE and the relay must postpone the uplink transmission or the feedback reception to another subframe.

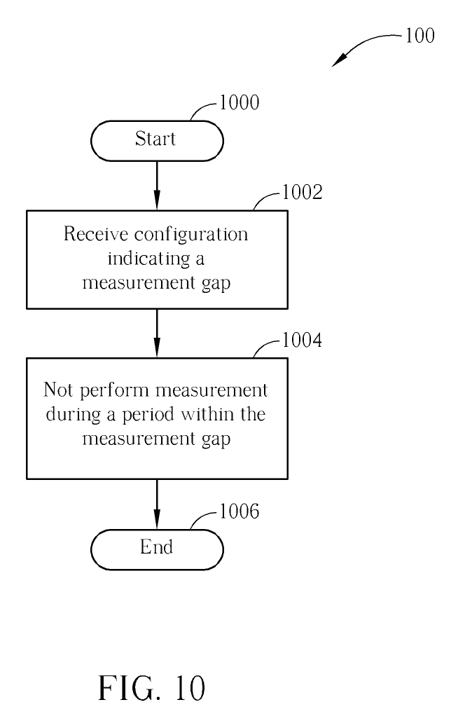

Please refer to FIG. 10, which is a flowchart of a process 100 according to an example of the present disclosure. The process 100 is used for handling behavior corresponding to scheduling for a UE in a wireless communication system. Preferably, the wireless communication system can be referred as to the wireless communication system 10 and include a relay and a serving base station. The process 100 may be complied into the program code 214 and includes the following steps:

Step 1000: Start.

Step 1002: Receive configuration indicating a measurement gap.

Step 1004: Not perform measurement during a period within the measurement gap.

Step 1006: End.

According to the process 100, the UE does not perform the measurement during a certain period or subframes within the measurement gap when receiving the measurement gap. Besides, the UE may receive a message sent or broadcast by the relay or the serving station. The message may indicate that certain period or which subframes skipped for the measurement. Preferably, the length of the measurement gap is dynamically configured by a network (e.g. E-UTRAN). In some examples, the UE may perform the measurement during period within the measurement gap. In other words, when the UE knows that the relay is receiving the downlink data from the base station at the certain subframe, the UE may not be able to receive the downlink data (e.g. reference signal for DL measurement, DL TTL bundling transmission, or DRX operation) from the relay.

When the UE is under coverage of the relay, the UE may determine that a downlink transmission from the serving base station to the relay is performed during the period. For example, the UE does not expect any downlink transmission from the relay on certain subframes (e.g. FAKE MBSFN subframes). In the other examples, when the UE is under coverage of the relay, the UE may determine that uplink transmission from the relay to the serving base station is performed during the period. For example, the UE does not expect any uplink grant on that certain subframes.

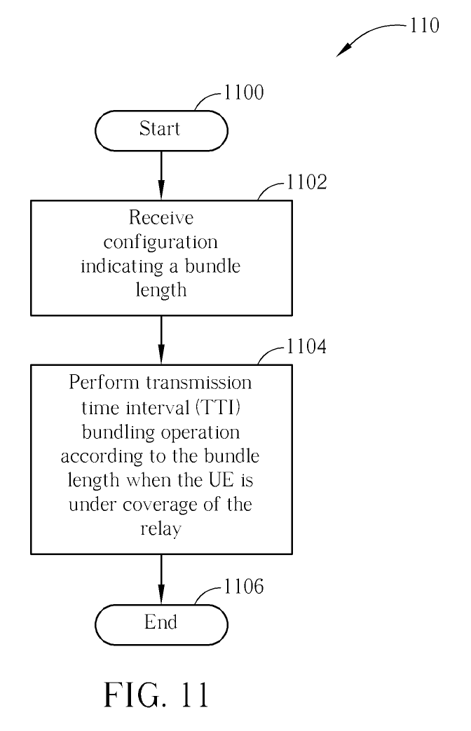

Please refer to FIG. 11, which is a flowchart of a process 110 according to an example of the present disclosure. The process 110 is used for handling behavior corresponding to scheduling for a UE in a wireless communication system. Preferably, the wireless communication system can be referred as to the wireless communication system 10 and include a relay and a serving base station. The process 110 may be complied into the program code 214 and includes the following steps:

Step 1100: Start.

Step 1102: Receive configuration indicating a bundle length.

Step 1104: Perform transmission time interval (TTI) bundling operation according to the bundle length when the UE is under coverage of the relay.

Step 1106: End.

According to the process 110, the UE may receive the configuration which indicates the bundle length (e.g. the number of subframes) and the number of transmissions. When the UE is under the coverage of the relay, the UE may perform TTI bundling operation according to the bundle length and the number of transmissions. Preferably, the TTI bundling operation is configured by the relay or the serving base station and the length of the TTI bundling is dynamically configured by a network (e.g. E-UTRAN) or fixed. Within the buddle length, transmission from the relay to the serving base station is not allowed so that the UE may transmit uplink transmission by in-band transmission consecutively. According to examples, the buddle length may indicate the number of the transmission opportunities, and thus the buddle length is not necessarily consecutive in time.

Besides, when the UE can not perform the uplink transmission at a subframe before all of the uplink transmission opportunities are finished, the UE does not count that uplink transmission as an opportunity out of all of the uplink transmission opportunities. For example, the TTI bundling starts from a subfram(N) and the TTI bundling has size of 4. In this situation, the UE can not perform uplink transmission at subframe(N+1), subframe(N+3), subframe(N+5) and subframe(N+6). It is more likely for the UE to perform the uplink transmission at subframe(N), subframe(N+2), subframe(N+4) and subframe(N+7).

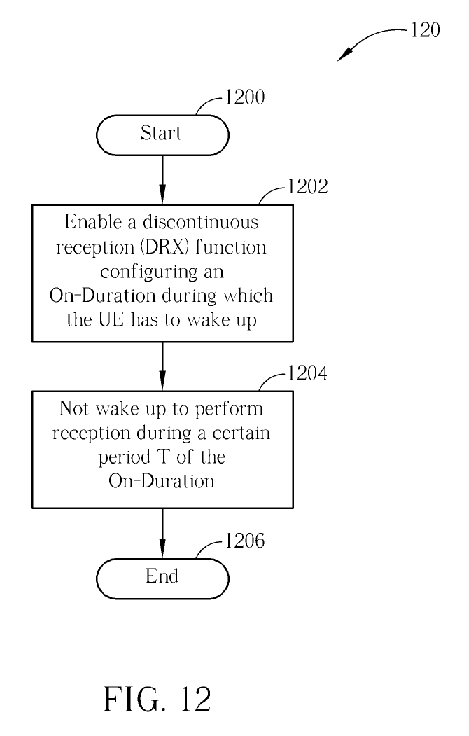

Please refer to FIG. 12, which is a flowchart of a process 120 according to an example of the present disclosure. The process 120 is used for handling behavior corresponding to scheduling for a UE in a wireless communication system. Preferably, the wireless communication system can be referred as to the wireless communication system 10 and include a relay and a serving base station. The process 120 may be complied into the program code 214 and includes the following steps:

Step 1200: Start.

Step 1202: Enable a discontinuous reception (DRX) function configuring an On-Duration during which the UE has to wake up.

Step 1204: Do not wake up to perform reception during a certain period T of the On-Duration.

Step 1206: End.

According to the process 120, the UE may enable the DRX function. The DRX function configures the On-Duration during which the UE has to wake up for reception. The On-Duration can be set by a timer. When the timer starts, the UE does not wake up to perform reception during the certain period T (or, subframes) of the On-Duration. In other words, when the timer is running, the UE does not need to wake up during the certain period T of the On-Duration. The timer could be an On-Duration timer, a retransmission timer or any timer related to timing counted for active time. In some examples, the UE may go to sleep or enter a sleep mode during the certain period of the On-Duration or at the certain suframes when the timer is running. Except the certain period of the On-Duration, the UE may still wake up to perform reception when the timer is running or when the timer does not expire. In some examples, the UE may stop the timer (e.g. on-duration timer, the retransmission timer) during the certain period T. In some examples, the UE may resume or restart the timer outside of the certain period T during the On-Duration.

When the UE is under the coverage of the relay, the UE may determine that a downlink transmission from the serving base station to the relay is performed during the certain period T. For example, the UE does not expect any downlink transmission from the relay on certain subframes (e.g. FAKE MBSFN subframes). In the other examples, when the UE is under coverage of the relay, the UE may determine that uplink transmission from the relay to the serving base station is performed during the certain period T. For example, the UE does not expect any uplink grant during that certain period T or on that certain subframes. Besides, the UE may receive a message sent or broadcast by the relay or the serving station. The message may indicate that certain period T or the subframes. Preferably, the certain period T and the subframes are related the in-band transmission. This means the relay can not transmit or receive at the same time.

Please note that the abovementioned steps including suggested steps can be realized by means that could be hardware, firmware known as a combination of a hardware device and computer instructions and data that reside as read-only software on the hardware device, or an electronic system. Examples of hardware can include analog, digital and mixed circuits known as microcircuit, microchip, or silicon chip. Examples of the electronic system can include system on chip (SOC), system in package (Sip), computer on module (COM), and the communication device 20 in which the processor 200 processes the program code 214 related to the abovementioned processes and the processed results can handling transmission status information in the wireless communication system 10.

To sum up, when the relay receive the report or a feedback signal corresponding to the transmission (e.g. uplink transmission or downlink transmission) from the base station or the UE, the relay can decide whether to continue/forward the report or the feedback for the UE or the base station, or whether to release/reschedule the resource for the transmission or feedback. Besides, through additional HARQ information, the UE can ensure the transmission/reception status or acknowledgement result and further avoid acknowledgement error or the NDI error. When multiple UEs are under relay coverage, the relay may perform synchronization with each UE by UE-specific synchronization signal. In addition, according to examples of the present disclosure, the UE may take into account scheduling between the relay and the base station.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for handling transmission and transmission status information for a relay capable of conveying data between a mobile device and abase station in a wireless communication system, the method comprising:
autonomously handling a first transmission or a first transmission report to the mobile device, or a first reception report or a first feedback signal corresponding to the first transmission, or resources for the first transmission or the first transmission report, or the first reception report or the first feedback signal corresponding to the first transmission, when the relay receives the first transmission or the first transmission report from the base station, or receives from the mobile device the first reception report or the first feedback signal corresponding to the first transmission, wherein the first transmission carries data or signaling that the base station attempts to send to the mobile device; and
autonomously handling a second transmission or a second transmission report to the base station, or a second reception report or a second feedback signal corresponding the second transmission, or resources for the second transmission or the second transmission report, or the second reception report or the second feedback signal corresponding to the second transmission, when the relay receives the second transmission or the second transmission report from the mobile device, or receives from the base station the second reception report or a second feedback signal corresponding to the second transmission, wherein the second transmission carries data or signaling that the mobile device attempts to send to the base station.

2. The method of claim 1, wherein autonomously handling the first transmission or the first transmission report to the mobile device, or the first reception report or the first feedback signal corresponding to the first transmission, or resources for the first transmission or the first transmission report, or the first reception report or the first feedback signal corresponding to the first transmission, when the relay receives the first transmission or the first transmission report from the base station, or receives from the mobile device the first reception report or the first feedback signal corresponding to the first transmission comprising at least one of:
determining whether to continue or forward the first transmission or the first transmission report to the mobile device, or the first reception report or the first feedback signal to the base station, when the relay receives the first transmission or the first transmission report from the base station, or receives from the mobile device the first reception report or the first feedback signal corresponding to the first transmission;
determining whether to release the resources for the first transmission or the first transmission report, when the relay receives the first transmission or the first transmission report from the base station, or receives from the mobile device the first reception report or the first feedback signal corresponding to the first transmission; and
determining whether to reschedule the resources for the first transmission or the first transmission report, when the relay receives the first transmission or the first transmission report from the base station, or receives from the mobile device the first reception report or the first feedback signal corresponding to the first transmission;
wherein the first transmission is a downlink transmission or a downlink retransmission; the first transmission report is a downlink transmission report, or a downlink retransmission report; the first reception report is sent by the mobile device; and
wherein autonomously handling the second transmission or the second transmission report to the base station, or the second reception report or the second feedback signal corresponding to the second transmission, or resources for the second transmission or the second transmission report, or the second reception report or the second feedback signal corresponding to the second transmission, when the relay receives the second transmission or the second transmission report from the mobile device, or receives from the base station the second reception report or the second feedback signal corresponding to the second transmission comprising at least one of:
determining whether to continue or forward the second transmission or the second transmission report to the base station, or the second reception report or the second feedback signal to the mobile device, when the relay receives the second transmission or the second transmission report from the mobile device, or receives from the base station the second reception report or the second feedback signal corresponding to the second transmission;
determining whether to release the resources for the second transmission or the second transmission report, when the relay receives the second transmission or the second transmission report from the mobile device, or receives from the base station the second reception report or the second feedback signal corresponding to the second transmission; and
determining whether to reschedule the resources for the second transmission or the second transmission report, when the relay receives the second transmission or the second transmission report from the mobile device, or receives from the base station the second reception report or the second feedback signal corresponding to the second transmission;
wherein the second transmission is a uplink transmission or a uplink retransmission; the second transmission report is a uplink transmission report, or a uplink retransmission report; the second reception report is sent by the base station.

3. The method of claim 2 further comprising:
indicating to the base station when the relay determines to release or reschedule the resources for the first transmission or the first transmission report; or
indicating to the base station when the relay determines to continue or forward the first transmission or the first transmission report to the mobile device, or the first reception report or the first feedback signal to the base station; or
indicating to the base station when the relay determines not to continue or forward the first transmission or the first transmission report to the mobile device, or the first reception report or the first feedback signal to the base station; or
indicating to the base station or the mobile device when the relay determines to release or reschedule the resources for the second transmission or the second transmission report; or
indicating to the base station or the mobile device when the relay determines to continue or forward the second transmission or the second transmission report to the base station, or the second reception report or the second feedback signal to the mobile device; or
indicating to the base station or the mobile device when the relay determines not to continue or forward the second transmission or the second transmission report to the base station, or the second reception report or the second feedback signal to the mobile device.

4. The method of claim 2 further comprising:
assisting at least one of the first transmission and the second transmission in sending the data or signaling for at least one of the first transmission and the second transmission for the mobile device, when the resources for the first transmission and the second transmission has been scheduled at the relay or when the relay snoops control signaling for at least one of the first transmission and the second transmission or snoops at least one of the first feedback signal and the second feedback signal.

5. A method for handling transmission status information for a communications device in a wireless communication system, the method comprising:
configuring a physical layer entity of the communications device to provide a medium access control (MAC) layer entity of the communications device with information of the physical layer entity associated with a transmission, a retransmission or related report or feedback signal; and
configuring the MAC layer entity to performing a hybrid automatic repeat request procedure according to the information.

6. The method of claim 5, wherein the information comprises at least one of modulation and coding scheme (MCS) information, timing of the transmission or retransmission, timing of a reception, correlation information, a power control level in relation to transmission times, and snooped control information.

7. The method of claim 5, wherein configuring the MAC layer entity to performing the hybrid automatic repeat request procedure according to the information comprises:
configuring the MAC layer entity to determine whether the transmission is a new transmission or a retransmission; or
configuring the MAC layer entity to determine whether the feedback signal is correct or not; or
configuring the MAC layer entity to determine whether continue or forward the transmission or the retransmission at uplink or whether continue or forward the transmission or the retransmission at downlink; or
configuring the MAC layer entity to determine whether to release or reschedule the resources for the transmission or the retransmission at uplink or to release or reschedule the resources for the transmission or the retransmission at downlink.

8. The method of claim 5, wherein the communications device is a user equipment (UE) or a relay.

9. A method for handling synchronization for a relay capable of conveying data between a mobile device and a base station in a wireless communication system, the method comprising:
transmitting a synchronization signal with a specific feature to the mobile device, wherein the mobile device performs synchronization with the relay according to the synchronization signal.

10. The method of claim 9, wherein the specific feature comprises at least one of a period, a pattern, resource, a root sequence, cell information, and a transmitting power level.

11. The method of claim 10, wherein at least one of the period, the pattern, the resource, the root sequence, the cell information, and the transmitting power level used for the synchronization signal at the relay is different from the one used at the base station, or wherein at least one of the period, the pattern, the resource, the root sequence, the cell information, and the transmitting power level used for the synchronization signal at the relay is the same as the one used at the base station.

12. The method of claim 11, wherein the cell information carried in the synchronization signal at the relay is the same as the one carried in the synchronization signal at the base station.

13. The method of claim 9 further comprising using the same cell identity as the one of the base station or using a different cell identity than the one of the base station, or having no cell identity.

14. The method of claim 9, wherein resource of the synchronization signal is allocated by the relay or the base station or is indicated to the mobile device by the relay or the base station.

15. The method of claim 9, wherein the relay is transparent or non-transparent to the mobile device and is operated in in-band transmission or out-band transmission.

16. A method for handling synchronization for a mobile device in a wireless communication system, the method comprising:
performing a first random access (RA) procedure to a base station;
acquiring a first uplink synchronization with the base station according to the first RA procedure;
performing a second RA procedure to a relay; and
acquiring a second uplink synchronization with the relay according to the second RA procedure.

17. The method of claim 16, wherein the first RA procedure and the second procedure is running simultaneously at a given subframe, or the first RA procedure is performed when the second RA procedure is completed, or the second RA procedure is performed when the first RA procedure is completed.

18. The method of claim 16, wherein the relay is informed of the first uplink synchronization through a first indication sent by the base station, or the base station is informed of the second uplink synchronization through a second indication sent by the relay.

19. A method for handling synchronization for a first communication device a wireless communication system, the first communication device having a first uplink synchronization of a mobile device to the first device, the method comprising:
acquiring a second uplink synchronization of the mobile device to a second communication device according to the first uplink synchronization.

20. The method of claim 19, wherein the step of acquiring the second uplink synchronization of the mobile device to the second communication device according to the first uplink synchronization comprising acquiring the second uplink synchronization according to a third uplink synchronization from the first communication device to the second communication device or a downlink synchronization of the second communication device to the first communication device or an indication sent by the second communication device when the first communication device has the first uplink synchronization with the mobile device.

21. The method of claim 19, wherein the first communication device is a relay while the second communication device is abase station, or the first communication device is the base station while the second communication device is the relay.

22. The method of claim 19, wherein the second uplink synchronization is indicated to the mobile device by the first communication device or the second communication device.

23. The method of claim 19, wherein the first uplink synchronization or the second uplink synchronization is defaulted by the mobile device or the first communication device or the second communication device.

24. A method for handling transmission scheduling for a first communication device in a wireless communication system, the method comprising:
scheduling uplink transmission from a mobile device to the first communication device or a second communication device according to at least one of synchronous uplink transmission, HARQ operation related to a UL grant, timing of downlink feedback of the uplink transmission and an in-band operation of a relay; and
scheduling downlink transmission to a mobile device from the first communication device or the second communication device according to at least one of adaptive downlink assignment, timing of uplink feedback of the downlink transmission and an in-band operation of the relay.

25. The method of claim 24, wherein the first communication device is a serving base station or a serving cell while the second communication device is the relay, or the first communication device is the relay while the second communication device is the serving base station or the serving cell.

26. The method of claim 25 further comprising the step of scheduling a plurality of subframes for the uplink transmission, a plurality of subframes for the downlink transmission, the downlink feedback of the uplink transmission or the uplink feedback of the downlink transmission; or
postponing at least one of a plurality of subframes for the uplink transmission, a plurality of subframes for the downlink transmission, the downlink feedback of the uplink transmission and the uplink feedback of the downlink transmission; or
avoiding at least one of a plurality of subframes for the uplink transmission, a plurality of subframes for the downlink transmission, the downlink feedback of the uplink transmission and the uplink feedback of the downlink transmission.

27. The method of claim 25, wherein the relay is transparent or non-transparent to the mobile device.

28. The method of claim 25, wherein the relay and the serving base station have the same cell identity or different cell identities, or relay has no cell identity.

29. A method for handling behavior corresponding to scheduling for a mobile device in a wireless communication system, the method comprising:
receiving configuration indicating a measurement gap; and
not performing measurement during a period within the measurement gap.

30. The method of claim 29 further comprising:
determining that a downlink transmission from a serving base station of the mobile device to a relay is performed during the period, when the mobile device is under coverage of the relay; or
determining that a uplink transmission from the relay to the serving base station is performed during the period, when the mobile device is under coverage of the relay.

31. The method of claim 30 further comprising:
receiving from the relay or the serving base station a message indicating the period.

32. The method of claim 29, wherein the length of the measurement gap is dynamic and configured by a network of the wireless communication system.

33. A method for handling behavior corresponding to scheduling for a mobile device in a wireless communication system, the method comprising:
receiving configuration indicating a bundle length; and
performing transmission time interval (TTI) bundling operation according to the bundle length when the mobile device is under coverage of a relay of the wireless communication system.

34. The method of claim 33, wherein receiving the configuration indicating the bundle length comprises receiving the configuration from the relay or a serving base station of the mobile device.

35. The method of claim 33, wherein the bundle length indicates the number of uplink transmission opportunities of the mobile device.

36. The method of claim 35 further comprising:
when the mobile device does not perform an uplink transmission at a subframe before all of the uplink transmission opportunities are finished, not counting the uplink transmission as an opportunity out of all of the uplink transmission opportunities.

37. The method of claim 33 further comprising:
performing an uplink transmission by in-band transmission within consecutive subframes of the bundle length, wherein no transmission from the relay to a serving base station of the mobile device is performed within the consecutive subframes.

38. A method for handling behavior corresponding to scheduling for a mobile device in a wireless communication system, the method comprising:
enabling a discontinuous reception function configuring an On-Duration during which the mobile device has to wake up; and
not waking up to perform reception during a period of the On-Duration.

39. The method of claim 38, wherein not waking up to perform reception during the period comprises:
not waking up to perform reception during the period when an on-duration timer, a retransmission timer or a timer related to timing counted for active time runs.

40. The method of claim 39 further comprising:
waking up to perform reception at the time outside the period when the on-duration timer, the retransmission timer or the timer related to timing counted for active time runs or does not expires; or
further comprising:
stopping the on-duration timer, the retransmission timer or the timer related to timing counted for active time during the period; and
resuming or restarting the on-duration timer, the retransmission timer or the timer related to timing counted for active time during the time outside the period.

41. The method of claim 38 further comprising:
determining that a downlink transmission from a serving base station of the mobile device to a relay is performed during the period, when the mobile device is under coverage of the relay; or
determining that an uplink transmission from the relay to the serving base station is performed during the period, when the mobile device is under coverage of the relay.

42. The method of claim 41 further comprising:
receiving from the relay or the serving base station a message indicating the period.
